(19) United States
(12) Patent Application Publication
(10) Pub. No.: US 2005/0069731 A1
(43) Pub. Date: Mar. 31, 2005

(54) Magneto-optical recording medium

(75) Inventors: Hiroyuki Awano, Noda-shi (JP); Susumu Imai, Toride-shi (JP); Hiroshi Ido, Moriya-shi (JP); Manabu Tani, Moriya-shi (JP)

Correspondence Address: OLIFF & BERRIDGE, PLC, P.O. BOX 19928, ALEXANDRIA, VA, 22320, US

(73) Assignee: HITACHI MAXELL, LTD., Ibaraki-shi (JP)

(21) Appl. No.: 10/949,658

(22) Filed: Sep. 27, 2004

(30) Foreign Application Priority Data
Sep. 29, 2003 (JP) 2003-337237

(51) Int. Cl. G11B 5/64

(52) U.S. Cl. 428/694 SC; 428/694 LE; 428/336

(57) ABSTRACT

A magneto-optical recording medium includes a recording layer, a reproducing layer in which information is subjected to expansion reproduction, a first intermediate layer which is provided between the recording layer and the reproducing layer, a recording magnetic field assist layer which is provided on a side opposite to a side of the first intermediate layer with respect to the recording layer, and a second intermediate layer which is provided between the recording layer and the recording magnetic field assist layer. The recording magnetic field assist layer exhibits perpendicular magnetization, which is one of an amorphous alloy film containing GdFeCo as major component and a multilayer film formed by alternately stacking transition metal layers and noble metal layers. The recording magnetic field assist layer generates the assist magnetic field during recording of information to form stable recording magnetic domains even when the external magnetic field is low.

### BACKGROUND OF THE INVENTION

1. Field of the Invention

The present invention relates to an information-recording medium of the type in which information is recorded by using a light beam and a magnetic field. In particular, the present invention relates to a magneto-optical recording medium which makes it possible to reliably perform recording and reproduction at higher densities.

2. Description of the Related Art

As the information society is advanced, the recording density has been remarkably improved for the external storage device in order to store an enormous amount of information. It is also demanded to further improve the recording density not only for the external storage device but also for the rewritable type magneto-optical recording medium such as 3.5-inch MO and minidisk. In general, the recording density, at which information can be recorded and reproduced on the optical recording medium such as CD and DVD, has any physical limit which is determined by the numerical aperture of the objective lens and the laser wavelength to be used. However, in the case of the magneto-optical recording medium, the super high density recording and reproduction, which exceed the recording and reproduction limit of the ordinary optical recording medium, are realized by using both techniques, i.e., the magnetic field modulation recording technique and the magnetic amplifying magneto-optical technique or the magnetic domain-expanding reproduction technique (for example, Japanese Patent Application Laid-open No. 8-7350 (see p. 2, FIGS. 1 to 8) and International Patent Publication WO 02/077987 (see pp. 6-25, FIGS. 1 to 21)).

The magnetic field modulation recording technique is such a technique that the recording is performed by changing the direction of the external magnetic field in accordance with the recording signal while radiating a light beam onto a predetermined area of a medium during the recording of information. In the magnetic field modulation recording technique, it is possible to improve the writing speed, because the overwrite can be performed without erasing information once.

The magnetic amplifying magneto-optical technique (also referred to as “MAMMOS” (Magnetic Amplifying Magneto-Optical System)) is such a technique that a magnetic domain, in which information has been recorded, is expanded during the reproduction of the information to reproduce the information from the expanded magnetic domain. Therefore, even when the recording magnetic domain (recording mark) is fine and minute, the recording magnetic domain can be expanded to perform the reproduction. Therefore, it is possible to reproduce information with a sufficient signal amplitude. Those suggested as the magnetic amplifying magneto-optical technique include those of a type in which a magnetic domain in a recording layer is transferred to a reproducing layer by radiating a reproducing light beam onto a magneto-optical recording medium to effect the heating, and the magnetic domain transferred to the reproducing layer is expanded with a reproducing magnetic field as disclosed in Japanese Patent Application Laid-open No. 8-7350, and those of a type in which no reproducing magnetic field is required when a magnetic domain, which is transferred from a recording layer to a reproducing layer, is expanded to perform the reproduction (hereinafter referred to as “Zero-Field MAMMOS”) as disclosed in International Patent Publication WO02/077987. In any one of the types, the recording magnetic domain, which is transferred from the recording layer to the reproducing layer, can be expanded to have a size approximate to the spot size of the reproducing light beam, when information is reproduced by radiating the reproducing light beam.

When the magnetic amplifying magneto-optical technique is used as described above, information can be reproduced with a large reproduced signal even when the recording magnetic domain is fine and minute. However, as information is progressively recorded at high recording densities, the size of the minimum recording magnetic domain is greatly decreased, and the shape of the recording magnetic domain tends to be disturbed or disordered. In order to avoid such an inconvenience, it is necessary that the shape of the recording magnetic domain is stably maintained by forming the recording magnetic domain with a large recording magnetic field. In general, when information is recorded on the magneto-optical recording medium by the magnetic field modulation recording technique, an external magnetic field, which is generated by using a magnetic coil, is applied to the magneto-optical recording medium to form the recording magnetic domain. However, the external magnetic field, which can be generated from the magnetic coil, has already arrived at the limit in view of the high speed recording as well.

A magnetic domain-expanding reproduction technique of the domain wall displacement type is also known. Japanese Patent Application Laid-open No. 2000-173116 discloses a magneto-optical recording medium including at least a first magnetic layer, a second magnetic layer, a third magnetic layer, a non-magnetic intermediate layer, and a fourth magnetic layer which are successively stacked or laminated, wherein the first magnetic layer is composed of a perpendicular magnetized film which has a large degree of domain wall displacement (domain wall motion) and which has a relatively small domain wall coercive force as compared with the third magnetic layer in the vicinity of a predetermined temperature, the second magnetic layer is composed of a magnetic layer which has a Curie temperature lower than those of the first magnetic layer and the third magnetic layer, the fourth magnetic layer is a perpendicular magnetized film in which directions of magnetization are aligned, and an area, in which directions of magnetization are aligned, is formed in the first magnetic layer by effecting magnetostatic coupling with respect to the first magnetic layer at a temperature of not less than a predetermined temperature higher than the Curie temperature of the second magnetic layer (claim 1). The fourth magnetic layer is composed of a magnetic material having a high coercivity such as TbFe and TbFeCo in order to possess the magnetic characteristic as described above. The fourth magnetic layer is initialized so that the direction of magnetization is constant during the recording.

In relation to the magneto-optical recording medium which is not based on the use of the magnetic domain-expanding reproduction technique, a method has been suggested, in which a non-magnetic layer and a recording auxiliary layer are provided under a recording layer to generate a magnetic field from the recording auxiliary layer, and thus information is recorded with a smaller external magnetic field. For example, reference may be made to Japanese Patent Application Laid-open No. 11-353725 (pp. 3 to 5, FIGS. 1 to 9). As for the magneto-optical recording medium described in this document, it is disclosed that the recording auxiliary layer preferably has a thickness of not less than 250 nm in order to sufficiently decrease the jitter.

Japanese Patent Application Laid-open No. 10-106055 describes a magneto-optical recording medium which includes a recording layer, a recording auxiliary layer, and a non-magnetic intermediate layer provided therebetween in order to reduce the recording magnetic field for the magneto-optical recording medium. The recording layer and the recording auxiliary layer are magnetostatically coupled to one another via the non-magnetic intermediate layer. It is necessary for the recording auxiliary layer to use a magnetic layer which is in an in-plane magnetization state at a temperature of not more than a temperature in the vicinity of the recording temperature and which is in a perpendicular magnetization state at a temperature of not less than a temperature in the vicinity of the recording temperature.

### SUMMARY OF THE INVENTION

The present invention has been made in order to solve the problem involved in the conventional technique as described above, an object of which is to provide a magneto-optical recording medium based on the use of the magnetic domain-expanding reproduction technique, wherein the magneto-optical recording medium makes it possible to form a more stable minute recording magnetic domain with a smaller magnetic field.

According to the present invention, there is provided a magneto-optical recording medium comprising:
a recording layer which is formed of a magnetic material and in which information is recorded as magnetic domains;
a reproducing layer which is formed of a magnetic material and in which the magnetic domain magnetically transferred from the recording layer is expanded;
a first intermediate layer which is formed of a magnetic material and which is provided between the recording layer and the reproducing layer;
a recording magnetic field assist layer which is one of an amorphous alloy film containing GdFeCo as major component and a multilayer film formed by alternately stacking transition metal layers and noble metal layers, the recording magnetic field assist layer being provided on a side opposite to a side of the first intermediate layer with respect to the recording layer, and exhibiting perpendicular magnetization; and
a second intermediate layer which is provided between the recording layer and the recording magnetic field assist layer and which cuts off or intercepts magnetic coupling between the recording layer and the recording magnetic field assist layer, wherein:
the recording magnetic field assist layer has a thickness of 30 to 190 nm.

### BRIEF DESCRIPTION OF THE DRAWINGS

FIG. 1 shows a schematic sectional view illustrating a magneto-optical recording medium manufactured in Example 1.

FIG. 2 shows the relationship between the external magnetic field and CNR in relation to the magneto-optical recording medium manufactured in Example 1.

FIG. 3 shows a magnetization curve at 25° C. of the magneto-optical recording medium manufactured in Example 1.

FIG. 4 shows the relationship between the radius of the reversed magnetic domain formed in a recording magnetic field assist layer of the magneto-optical recording medium manufactured in Example 1 and the leak magnetic field generated from the reversed magnetic domain in the recording magnetic field assist layer.

FIG. 5 shows the relationship between the thickness of the recording magnetic field assist layer of the magneto-optical recording medium of the present invention and the external magnetic field required to obtain CNR of 40 dB.

FIG. 6 shows the relationship between CNR and the coercivity at 25° C. of the magneto-optical recording medium of the present invention.

FIG. 7 shows magnetization states of respective magnetic layers of a magneto-optical recording medium based on the Zero-Field MAMMOS manufactured in Example 3, illustrating the magnetization states obtained immediately before the magnetic domain in the reproducing layer is expanded.

FIG. 8 shows magnetization states of the respective magnetic layers of the magneto-optical recording medium based on the Zero-Field MAMMOS manufactured in Example 3, wherein FIG. 8A shows the magnetization states obtained when the magnetic domain in the reproducing layer begins to be expanded, and FIG. 8B shows the magnetization states obtained when the magnetic domain in the reproducing layer is expanded.

FIG. 9 shows magnetization states of the respective magnetic layers of the magneto-optical recording medium based on the Zero-Field MAMMOS manufactured in Example 3, illustrating the magnetization states obtained when the thickness of the recording magnetic field assist layer is thick.

### DESCRIPTION OF THE PREFERRED EMBODIMENTS

The magneto-optical recording medium of the present invention is a magneto-optical recording medium which is based on the use of the magnetic amplifying magneto-optical technique or the magnetic domain-expanding reproduction technique. In particular, the magneto-optical recording medium is preferably usable as a magneto-optical recording medium based on the Zero-Field MAMMOS. The magneto-optical recording medium based on the Zero-Field MAMMOS principally includes the recording layer which is formed of the rare earth transition metal and which exhibits perpendicular magnetization, the reproducing layer which is formed of the rare earth transition metal and which exhibits the perpendicular magnetization, and the first intermediate layer (hereinafter referred to as “trigger layer”) which is formed of the magnetic material and which exhibits the perpendicular magnetization. The recording layer, the trigger layer, and the reproducing layer are subjected to the magnetic exchange coupling before being irradiated with the reproducing light beam. When the reproducing light beam is radiated onto the magneto-optical recording medium to effect the heating upon the reproduction of information, and the exchange coupling force, which has been exerted between the recording layer and the reproducing layer, is cut off or intercepted, then the magnetic domain, which is transferred from the recording layer to the reproducing layer, is expanded to perform the reproduction.

The recording layer of the magneto-optical recording medium based on the Zero-Field MAMMOS is formed of the rare earth transition metal alloy composed of, for example, elements of Tb, Fe, and Co, which is designed so that the transition metal-dominant or transition metal-rich ferri-magnetization from room temperature to the Curie temperature. Further, the composition is selected so that the perpendicular magnetized film is obtained. The reproducing layer is formed of the rare earth transition metal alloy composed of, for example, Gd, Fe, and Co, which is designed so that the rare earth metal-dominant or rare earth metal-rich ferri-magnetization is exhibited from room temperature to the Curie temperature. Further, the composition is selected so that the perpendicular magnetized film is obtained. The trigger layer is formed of the rare earth transition metal alloy composed of, for example, Tb and Fe.

The magneto-optical recording medium of the present invention is characterized in that the magneto-optical recording medium, which is based on the use of the magnetic domain-expanding reproduction technique, further has the recording magnetic field assist layer which is provided on the side opposite to the side of the trigger layer in relation to the recording layer, and the second intermediate layer which is provided between the recording layer and the recording magnetic field assist layer. The recording magnetic field assist layer is such a layer that the assist magnetic field is generated during the recording of information to supplement the insufficient amount of the recording magnetic field. The second intermediate layer is a layer to cut off or intercept the magnetic exchange coupling between the recording layer and the recording magnetic field assist layer. The second intermediate layer may be formed of a paramagnetic material or a non-magnetic material.

In the magneto-optical recording medium of the present invention, the assist magnetic field is generated during the recording of information from the recording magnetic field assist layer provided on the side opposite to the side of the trigger layer with respect to the recording layer. The assist magnetic field is superimposed on the external magnetic field generated, for example, from a magnetic coil, and it is possible to increase the recording magnetic field. That is, even when the external magnetic field, which is generated from the magnetic coil or the like, is small, the assist magnetic field, which is generated from the recording magnetic field assist layer, can be used to generate the sufficiently large recording magnetic field. Therefore, even when the high recording density of information is advanced, and the recording magnetic domain becomes more minute, then the sufficiently stable recording magnetic domain can be formed with the relatively small external magnetic field.

According to a verifying experiment performed by the inventors, it is necessary that the thickness of the recording magnetic field assist layer of the magneto-optical recording medium of the present invention is 30 to 190 nm. In relation to this feature, the following consideration may be made. That is, if the thickness of the recording magnetic field assist layer is thinner than 30 nm, any sufficient assist magnetic field is not generated. On the other hand, if the thickness of the recording magnetic field assist layer is thicker than 190 nm, the leak magnetic field from the recording magnetic field assist layer exerts any harmful influence during the reproduction on the magnetic domain-expanding reproduction operation.

In the magneto-optical recording medium of the present invention, an initially magnetized area of the magneto-optical recording medium may have a coercivity of not more than 150 Oe at 25° C.

The coercivity of the magneto-optical recording medium of the present invention at 25° C. may be determined from a magnetization curve obtained from the magnetic field dependency such as the anomalous Hall effect and the magnetic or magneto-optical polar Kerr effect.

In the magneto-optical recording medium of the present invention, the recording magnetic field assist layer may have a Curie temperature which is not less than a Curie temperature of the recording layer, and the recording magnetic field assist layer may have a coercivity of not more than 150 Oe at 25° C.

In the magneto-optical recording medium of the present invention, it is considered that when a recording magnetic field is applied to the magneto-optical recording medium to record the information in the recording layer, magnetization of the recording magnetic field assist layer turns to a direction of the recording magnetic field, and thus the assist magnetic field directed to the recording layer is generated.

In the magneto-optical recording medium of the present invention, the recording magnetic field assist layer may be the amorphous alloy film containing GdFeCo as the major component or the multilayer film which is formed by stacking a transition metal layer and a noble metal layer alternately and repeatedly. The alternately stacked multilayer film composed of the transition metal layers and the noble metal layers may be a multilayer film composed of a base material of, for example, Co/Pt, Co/Pd, CoNi/Pt, or CoNi/Pd.

The recording magnetic field assist layer of the magneto-optical recording medium of the present invention is the perpendicular magnetized film having the coercivity as described above (not more than 150 Oe). In particular, the recording magnetic field assist layer may be the amorphous alloy film containing GdFeCo as the major component or the multilayer film obtained by alternately stacking the transition metal layers and the noble metal layers. In order to improve the movement of the magnetic domain in the recording magnetic field assist layer, an element such as Cr, Al, and B may be added by about 0.5 to about 5 at. % to the recording magnetic field assist layer.

In the magneto-optical recording medium of the present invention, information in the recording layer may be recorded in accordance with the magnetic field modulation recording system. The recording magnetic field assist layer may be applied to an information-recording medium, especially to a magnetic recording medium. When the recording magnetic field assist layer is applied to a magnetic recording medium on which information is recorded in the recording layer in accordance with the heat assist magnetic recording system, it is possible to perform the super high density recording with a smaller external magnetic field.

The magneto-optical recording medium of the present invention may further comprise a third intermediate layer which is formed of a material that exhibits paramagnetism or non-magnetism at room temperature, wherein the third intermediate layer may be provided between the recording layer and the first intermediate layer and/or between the reproducing layer and the first intermediate layer.

Those usable for the second and third intermediate layers may include, for example, magnetic materials of rare earth metals such as Gd and Tb and alloys containing minute amounts of Fe, Ni, and Co in the rare earth metals with Curie temperatures of not more than room temperature, and materials having conductive electrons such as Al and Cu. Those usable for the second and third intermediate layers may include, for example, dielectric materials having no conductive electron such as SiN and SiO₂. In particular, the second intermediate layer is preferably formed of, for example, Al, Al alloy, Ag alloy, Pd alloy, or Cu alloy. The thickness thereof may be about 1 to 20 nm.

In the magneto-optical recording medium of the present invention, an external magnetic field may be reduced to be not more than 200 Oe when the information is recorded in the recording layer.

Examples of the magneto-optical recording medium according to the present invention will be specifically explained below. However, the present invention is not limited thereto.

### EXAMPLE 1

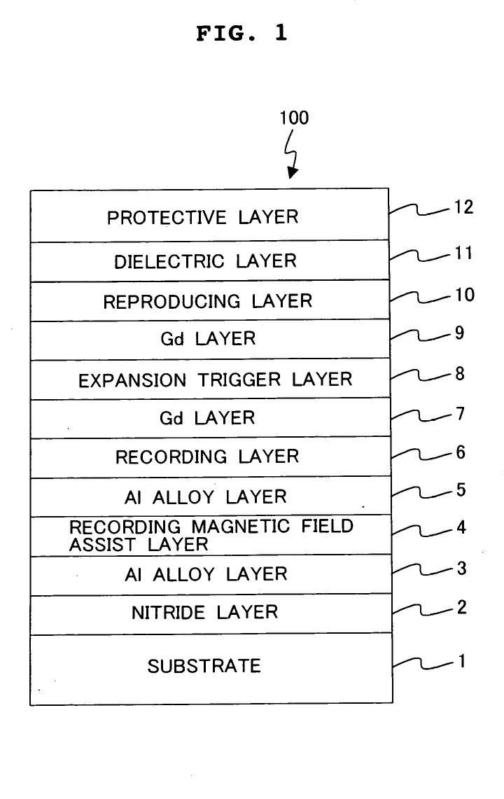

In Example 1, a magneto-optical recording medium based on the Zero-Field MAMMOS was manufactured. FIG. 1 shows a schematic sectional view illustrating the magneto-optical recording medium manufactured in Example 1. As shown in FIG. 1, the magneto-optical recording medium 100 manufactured in Example 1 has a structure including a nitride layer 2, an Al alloy layer 3, a recording magnetic field assist layer 4, an Al alloy layer 5 (second intermediate layer), a recording layer 6, a Gd layer 7 (third intermediate layer), an expansion trigger layer 8 (first intermediate layer), a Gd layer 9 (third intermediate layer), a reproducing layer 10, a dielectric layer 11, and a protective layer 12 which are successively stacked or laminated on a substrate 1. As shown in FIG. 1, the magneto-optical recording medium 100 manufactured in Example 1 is a magneto-optical recording medium based on the Zero-Field MAMMOS of the type in which the reproducing light beam is radiated on the side opposite to the side of the substrate 1 (hereinafter referred to as “first surface type”). The magneto-optical recording medium 100 was manufactured as follows by using a high frequency sputtering apparatus (not shown).

At first, a polycarbonate substrate, on which a groove having a land width of 200 nm, a groove width of 300 nm, and a groove depth of 45 nm was formed, was used for the substrate 1. The substrate 1 was installed to a film formation chamber of the high frequency sputtering apparatus, and then the respective layers were formed as follows.

SiN was formed as the nitride layer 2 to have a thickness of 5 nm on the substrate 1. Subsequently, AlTiSi was formed as the Al alloy layer 3 to have a thickness of 20 nm on the nitride layer 2.

Subsequently, a GdFeCo amorphous alloy was formed as the recording magnetic field assist layer 4 to have a thickness of 100 nm on the Al alloy layer 3. The Curie temperature of the recording magnetic field assist layer 4 was higher than 300° C. The recording magnetic field assist layer 4 exhibited the perpendicular magnetization from room temperature to a temperature in the vicinity of the Curie temperature. Subsequently, AlTiSi was formed as the Al alloy layer 5 to have a thickness of 5 nm on the recording assist layer 4.

Subsequently, a TbFeCo amorphous alloy was formed as the recording layer 6 to have a thickness of 60 nm on the Al alloy layer 5. The Curie temperature of the recording layer 6 was about 270° C., and the compensation temperature was not more than room temperature. The recording layer 6 exhibited the perpendicular magnetization from room temperature to the Curie temperature.

Further, Gd was formed as the Gd layer 7 to have a thickness of 0.5 nm on the recording layer 6. Subsequently, a TbGdFe amorphous alloy was formed as the expansion trigger layer 8 to have a thickness of 10 nm on the Gd layer 7. The expansion trigger layer 8 exhibited the perpendicular magnetization from room temperature to the Curie temperature. Subsequently, Gd was formed as the Gd layer 9 to have a thickness of about 0.5 nm on the expansion trigger layer 8. The Gd layers 7, 9 are the layers to control the exchange coupling forces between the recording layer 6 and the expansion trigger layer 8 and between the expansion trigger layer 8 and the reproducing layer 10 as described later on. According to a verifying experiment performed by the inventors, it has been revealed that the reproduction characteristics are further improved by inserting the Gd layer of about 0.5 nm between the recording layer 6 and the expansion trigger layer 8 and/or between the expansion trigger layer 8 and the reproducing layer 10 as described later on.

Subsequently, a GdFeCo amorphous alloy was formed as the reproducing layer 10 to have a thickness of 25 nm on the Gd layer 9. The Curie temperature of the reproducing layer 10 was about 250° C., and the compensation temperature was in the vicinity of the Curie temperature. The reproducing layer 10 exhibited the perpendicular magnetization from room temperature to the Curie temperature.

In the magneto-optical recording medium 100 manufactured in Example 1, the composition was adjusted so that the compensation temperature Tcomp2 of the expansion trigger layer 8 was not more than room temperature, and the compensation temperature Tcomp1 of the reproducing layer 10 was in the vicinity of 250° C. as described above. Thus, the magneto-optical recording medium 100 was formed to hold the relationship of Tcomp2<Tr<Tcomp1 with respect to the reproducing temperature Tr. In this arrangement, in the vicinity of the reproducing temperature Tr, the overall magnetization of the reproducing layer 10 exhibits the rare earth metal-dominant magnetization, and the overall magnetization of the expansion trigger layer 8 exhibits the transition metal-dominant magnetization. Therefore, in the vicinity of the reproducing temperature Tr, the overall magnetizations of the reproducing layer 10 and the expansion trigger layer 8 are in the mutually opposite directions, and the repulsive force is generated. That is, the magneto-optical recording medium 100 manufactured in Example 1 is a magneto-optical recording medium based on the Zero-Field MAMMOS of such a type that the magnetic domain-expanding action is effected by utilizing the repulsive force generated between the reproducing layer 10 and the expansion trigger layer 8 in the vicinity of the reproducing temperature Tr.

Subsequently, SiN was formed as the dielectric layer 11 to have a thickness of 40 nm on the reproducing layer 10.

After the respective layers 2 to 11 were formed on the substrate 1 by using the high frequency sputtering apparatus as described above, the magneto-optical recording medium 100 was taken out from the high frequency sputtering apparatus. Finally, an ultraviolet-curable resin was applied onto the dielectric layer 11 to form the protective layer 12 having a thickness of about 15 μm by the spin coat method. Thus, the magneto-optical recording medium 100 based on the Zero-Field MAMMOS of the first surface type having the stacked structure shown in FIG. 1 was manufactured.

### COMPARATIVE EXAMPLE 1

In Comparative Example 1, a magneto-optical recording medium based on the Zero-Field MAMMOS was manufactured in the same manner as in Example 1 except that the recording magnetic field assist layer and the Al alloy layer were not provided.

### Dependency of CNR on Recording Magnetic Field

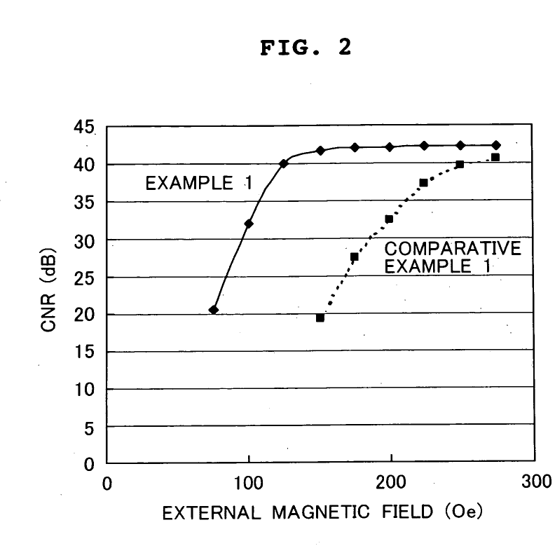

The dependency of CNR (carrier to noise ratio) on the external magnetic field was measured for the magneto-optical recording media manufactured in Example 1 and Comparative Example 1. The measurement was performed by using an evaluating machine (not shown) provided with an optical head having a wavelength of 405 nm and a numerical aperture NA=0.85 of an objective lens and a magnetic coil for generating the external magnetic field during the recording of information. The external magnetic field, which was generated from the magnetic coil, was applied to the magneto-optical recording media manufactured in Example 1 and Comparative Example 1 while changing the external magnetic field from 75 Oe to 275 Oe. Recording magnetic domains (recording marks) having a mark length of 100 nm were formed in the recording layer with the respective external magnetic fields. The recording marks were formed in accordance with the magnetic field modulation system. CNR was measured by using the evaluating machine for the recording marks formed with the respective external magnetic fields. Obtained results are shown in FIG. 2.

As clarified from FIG. 2, the following fact has been revealed. That is, CNR of not less than 40 dB cannot be obtained unless the external magnetic field is not less than about 250 Oe in the case of the magneto-optical recording medium manufactured in Comparative Example 1. On the contrary, in the case of the magneto-optical recording medium manufactured in Example 1, CNR of not less than 40 dB can be obtained by forming the recording magnetic domains with the external magnetic field of not less than about 125 Oe. That is, it has been revealed that sufficiently satisfactory reproduction characteristics are obtained by providing the recording magnetic field assist layer as in the magneto-optical recording medium manufactured in Example 1, even when the recording magnetic domains are formed while greatly reducing the external magnetic field to be generated by the magnetic coil.

### Measurement of Coercivity

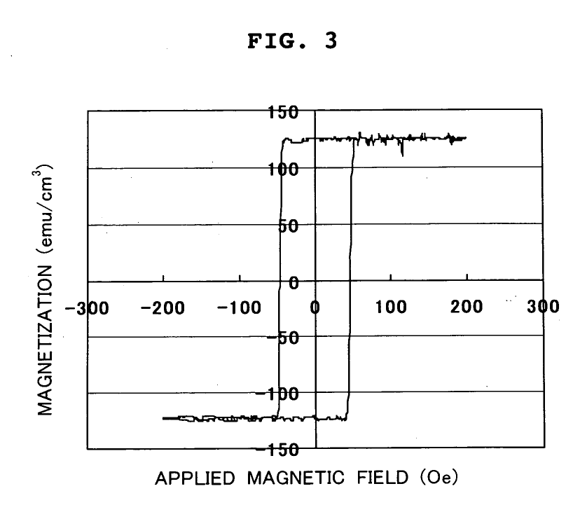

The dependency of the magnetization of the magneto-optical recording medium manufactured in Example 1 on the magnetic field was measured to measure the coercivity of the magneto-optical recording medium. At first, the magneto-optical recording medium manufactured in Example 1 was once heated to 130° C., and an external magnetic field of 16 kOe was applied in the direction perpendicular to the film surface to effect the magnetization (initialization). The dependency of the magnetization on the magnetic field was investigated at a temperature in the vicinity of 25° C. for the initialized magneto-optical recording medium. An obtained result is shown in FIG. 3.

As clarified from FIG. 3, a magnetization curve having a coercivity of 47 Oe was observed for the magneto-optical recording medium manufactured in Example 1. The coercivity of the single layer of the recording magnetic field assist layer 4 at 25° C. was measured in the same manner as described above. As a result, the coercivity was 45 Oe. That is, the coercivity of the magneto-optical recording medium obtained from the magnetization curve shown in FIG. 3 has approximately the same value as that of the coercivity of the single layer of the recording magnetic field assist layer 4. Therefore, it is considered that the coercivity of the magneto-optical recording medium obtained from the magnetization curve shown in FIG. 3 corresponds to the magnetization reversal of the recording magnetic field assist layer. The dependency of the magneto-optical polar Kerr rotation angle on the magnetic field was measured from the side of the recording magnetic field assist layer to investigate the magnetization curve for a magneto-optical recording medium in which the Al alloy layer 3 disposed on the side of the substrate as shown in FIG. 1 was changed to SiN. As a result, a coercivity of 48 Oe was obtained, and thus approximately the same coercivity as that of the magneto-optical recording medium of Example 1 was obtained. That is, it has been revealed that approximately the same value as that of the coercivity of the recording magnetic field assist layer is obtained for the coercivity of the magneto-optical recording medium itself, in the case of the magneto-optical recording medium having the recording magnetic field assist layer as in Example 1.

### Calculation of Leak Magnetic Field

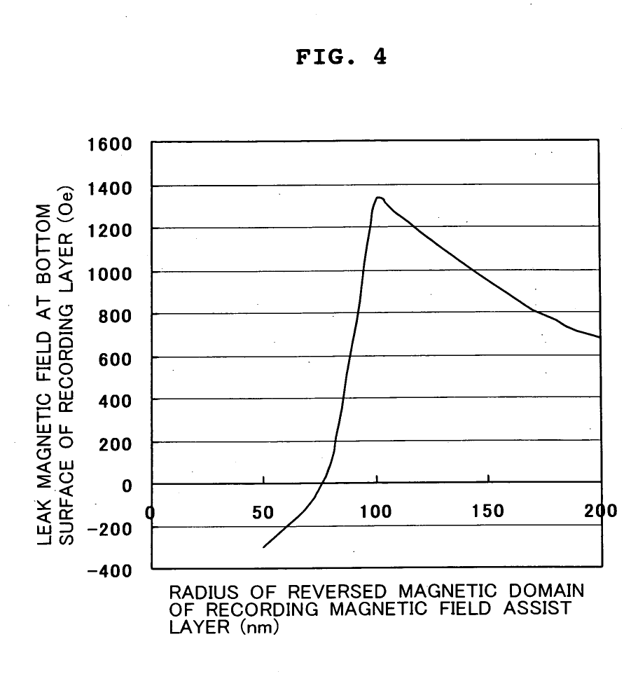

A blue laser, which had a linear velocity of 4 m/sec, a pulse duty of 35%, and a laser power of 9 mW, was radiated onto the magneto-optical recording medium manufactured in Example 1, and the heat distribution of the magneto-optical recording medium was calculated to calculate the leak magnetic field distribution generated from the reversed magnetic domain having the radius d formed in the recording magnetic field assist layer when the recording pulse was radiated. In this procedure, the recording magnetic domain having a radius of 100 nm was formed in the recording layer, while the reversed magnetic domains (magnetic domains having magnetization in the direction opposite to that of the magnetization of the recording magnetic domain in the recording layer), in which the radius d was changed from 50 nm to 200 nm, were formed in the recording magnetic field assist layer to calculate the leak magnetic field from the reversed magnetic domain in the recording magnetic field assist layer to be applied to the bottom surface (surface of the recording layer 6 on the side of the Al alloy layer 5 in FIG. 1) of the recording magnetic domain of the recording layer. In this procedure, the leak magnetic field generated from the recording magnetic field assist layer was estimated for the case in which the recording magnetic domain in the recording layer was not reversed. An obtained result is shown in FIG. 4. FIG. 4 shows the change of the perpendicular component of the leak magnetic field from the reversed magnetic domain of the recording magnetic field assist layer to be applied to the recording magnetic domain bottom surface of the recording layer.

As clarified from FIG. 4, the following fact has been revealed. That is, when the radius of the recording magnetic domain of the recording layer is 100 nm, the leak magnetic field, which is applied to the recording magnetic domain bottom surface of the recording layer, is maximized by allowing the radius of the reversed magnetic domain of the recording magnetic field assist layer to be approximately identical to the radius of the recording magnetic domain of the recording layer (about 100 nm). As a result, the large assist magnetic field, which exceeds 1,000 Oe, acts on the bottom surface of the recording magnetic domain of the recording layer. The formation of the recording magnetic domain of the recording layer arises from the bottom surface of the recording layer. Therefore, the following fact has been revealed according to this result. That is, when the radius of the reversed magnetic domain of the recording magnetic field assist layer is approximately the same as the radius of the recording magnetic domain of the recording layer, then the large assist magnetic field exceeding 1,000 Oe is applied to the bottom surface of the recording magnetic domain of the recording layer, and the assist magnetic field beneficially acts on the formation of the recording magnetic domain.

The in-plane component of the leak magnetic field generated from the reversed magnetic domain formed in the recording magnetic field assist layer was also calculated. As a result, the following fact has been revealed in the same manner as for the leak magnetic field distribution of the perpendicular component shown in FIG. 4. That is, when the radius of the reversed magnetic domain of the recording magnetic field assist layer is about 100 nm, a large leak magnetic field exceeding 1,000 Oe acts on the bottom surface of the recording magnetic domain of the recording layer. Upon the magnetization reversal, the magnetic field in the in-plane direction acts as the torque to facilitate the magnetization reversal. Therefore, according to this result, it is considered that the leak magnetic field in the in-plane direction generated from the reversed magnetic domain of the recording magnetic field assist layer also plays an important role for the magnetization reversal of the recording layer.

### EXAMPLE 2

In Example 2, a magneto-optical recording medium based on the Zero-Field MAMMOS was manufactured in the same manner as in Example 1 except that the Gd layers 7, 9 were not provided.

Recording magnetic domains having a mark length of 100 nm were recorded in the recording layer of the magneto-optical recording medium manufactured in Example 2 in the same manner as in Example 1 to measure the dependency of CNR on the external magnetic field as obtained from the recording magnetic domains. As a result, approximately the same characteristic as that of Example 1 was obtained for the external magnetic field sensitivity of CNR. When the recording magnetic domain was formed with an external magnetic field of 200 Oe, CNR of 40.6 dB was obtained. When the comparison was made with Comparative Example 1, it has been revealed that CNR of not less than 40 dB is obtained with the external magnetic field which is sufficiently lower than that for the magneto-optical recording medium of Comparative Example 1. That is, it has been revealed that the satisfactory reproduction characteristic is obtained by providing the recording magnetic field assist layer in the same manner as in Example 1 even when the recording magnetic domain is formed by greatly reducing the external magnetic field to be generated by the magnetic coil. When the comparison is made with Example 1, CNR is slightly lowered (lowered by about 1.4 dB). However, this results from the presence or absence of the Gd layer. It is considered that the Gd layer contributes to only the reproduction characteristic.

### EXAMPLE 3

In Example 3, various magneto-optical recording media based on the Zero-Field MAMMOS having different thicknesses of recording magnetic field assist layers were manufactured. The magneto-optical recording media were manufactured in the same manner as in Example 1 except that the thickness of the recording magnetic field assist layer was changed within a range of 10 nm to 250 nm.

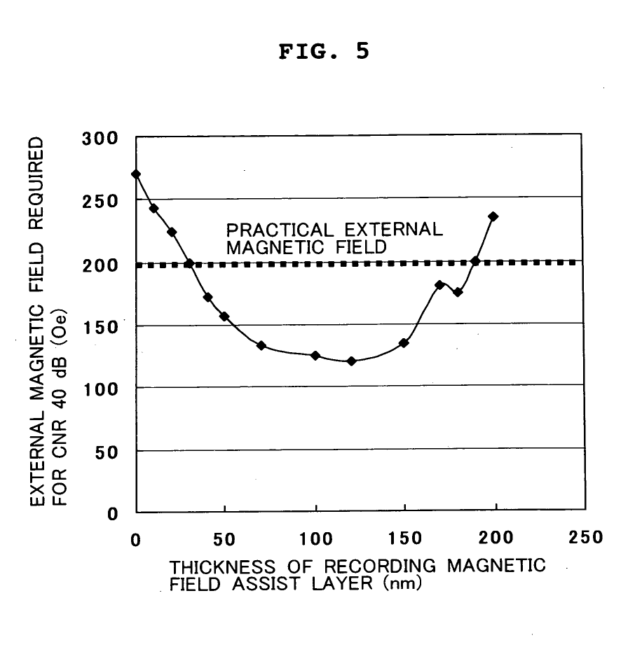

Recording magnetic domains having a mark length of 100 nm were formed in the recording layers while changing the external magnetic field from the magnetic coil within a range of 75 Oe to 275 Oe for the various magneto-optical recording media in which the thickness of the recording magnetic field assist layer was changed. The external magnetic field, with which CNR obtained from the respective recording magnetic domains exceeded 40 dB, was measured. However, CNR was obtained by using the evaluating machine employed in Example 1. An obtained result is shown in FIG. 5.

FIG. 5 shows the change of the external magnetic field required to obtain CNR=40 dB with respect to the thickness of the recording magnetic field assist layer. As clarified from FIG. 5, the following fact has been revealed. That is, the external magnetic field, which is required to obtain CNR=40 dB, is initially decreased as the thickness of the recording magnetic field assist layer is increased. However, the required external magnetic field is minimized when the thickness of the recording magnetic field assist layer is about 120 nm. After that, when the thickness is increased, the required external magnetic field is increased as well. That is, it is appreciated that the thickness of the recording magnetic field assist layer to some extent is required to generate the sufficient assist magnetic field in the recording magnetic field assist layer. Further, as clarified from FIG. 5, it has been revealed that if the thickness of the recording magnetic field assist layer is too thick, the required external magnetic field is increased.

In general, taking the high speed data transfer into consideration, it is preferable that the external magnetic field is not more than 200 Oe. Therefore, in order to obtain CNR of 40 dB with the external magnetic field of not more than 200 Oe, it has been revealed that the thickness of the recording magnetic field assist layer is required to be about 30 nm to about 190 nm as indicated by a broken line shown in FIG. 5. In particular it has been revealed that CNR of 40 dB is obtained with the external magnetic field of not more than 150 Oe when the thickness of the recording magnetic field assist layer is about 50 nm to about 160 nm.

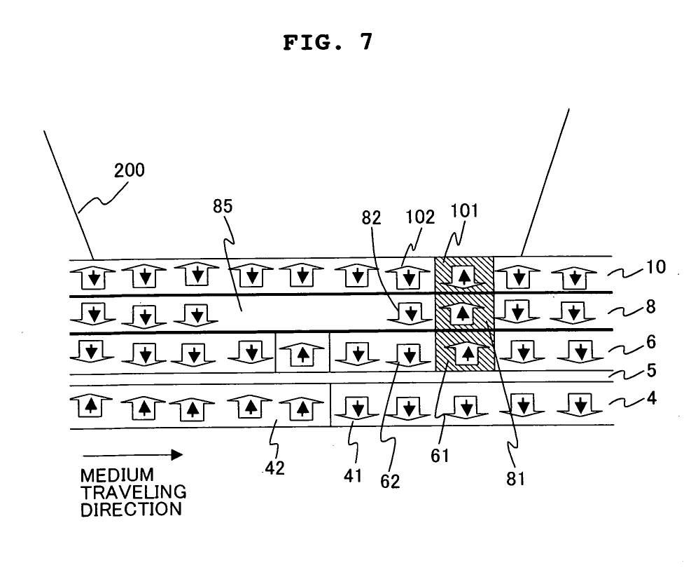

The reason, why the external magnetic field required to obtain CNR of 40 dB is increased if the thickness of the recording magnetic field assist layer is too thick as shown in FIG. 5, will now be briefly explained with reference to FIGS. 7 to 9. FIGS. 7 to 9 show magnetization states of the reproducing layer 10, the expansion trigger layer 8, the recording layer 6, the Al alloy layer 5, and the recording magnetic field assist layer 4 when the magneto-optical recording medium based on the Zero-Field MAMMOS manufactured in this embodiment is irradiated with the reproducing light beam 200. However, in order to simplify the explanation, the Gd layers 7, 9, which are disposed between the reproducing layer 10 and the expansion trigger layer 8 and between the recording layer 6 and the expansion trigger layer 8, are omitted from the drawings of in FIGS. 7 to 9.

As described above, in this embodiment, each of the reproducing layer 10, the expansion trigger layer 8, the recording layer 6, and the recording magnetic field assist layer 4 is formed of the rare earth transition metal amorphous alloy. Therefore, the spin of the rare earth metal and the spin of the transition metal are directed in the mutually opposite directions in each of the magnetic layers. Therefore, the magnetization, which is based on the spin of the rare earth metal, is directed in the direction mutually opposite to the direction of the magnetization which is based on the spin of the transition metal. As a result, the overall magnetization of each of the magnetic layers is the difference between the magnetization of the rare earth metal and the magnetization of the transition metal. That is, when the magnetization of the rare earth metal is larger than the magnetization of the transition metal (referred to as “rare earth-dominant (rare earth rich: RE rich)” as well), the overall magnetization of the magnetic layer is directed in the same direction as that of the magnetization of the rare earth metal. On the contrary, when the magnetization of the transition metal is larger than the magnetization of the rare earth metal (referred to as “transition metal-dominant (transition metal rich: TM rich)” as well), the overall magnetization of the magnetic layer is directed in the same direction as that of magnetization of the transition metal.

In the magnetization states shown in FIGS. 7 to 9, the thick blanked arrow indicates the direction of the overall magnetization of the magnetic layer, and the thin solid arrow indicates the direction of magnetization of the transition metal. In this embodiment, the reproducing layer 10 is formed of the rare earth transition metal amorphous alloy which exhibits the RE rich magnetization at room temperature. Therefore, as shown in FIGS. 7 to 9, the overall magnetization in the reproducing layer 10 (thick blanked arrows) is in the direction opposite to the direction of the magnetization of the transition metal (thin solid arrows). On the other hand, each of the expansion trigger layer 8, the recording layer 6, and the recording magnetic field assist layer 4 is formed of the rare earth transition metal amorphous alloy which exhibits the TM rich magnetization at room temperature. Therefore, as shown in FIGS. 7 to 9, the overall magnetization of the expansion trigger layer 8, the recording layer 6, and the recording magnetic field assist layer 4 is in the same direction as that of the magnetization of the transition metal.

The recording magnetic field assist layer 4 is the perpendicular magnetized film having the small coercivity. Therefore, it is considered that the magnetic domain of the recording layer 6 is transferred to the recording magnetic field assist layer 4 in some cases. However, it is also considered that any magnetic domain shape, which is irrelevant to the magnetization state of the recording layer 6, is formed. The latter case is assumed in FIGS. 7 to 9.

In the following description, the consideration will be made about the magnetic domain 61 of the recording layer 6, the magnetic domain 81 of the expansion trigger layer 8, and the magnetic domain 101 of the reproducing layer 10 (hatched portions shown in FIG. 7) which are arranged in an identical vertical line in FIG. 7.

FIG. 7 shows the magnetization state obtained immediately before the magnetic domain 101 of the reproducing layer 10 is expanded. In the magnetization state shown in FIG. 7, the magnetic domain 61 of the recording layer 6, the magnetic domain 81 of the expansion trigger layer 8, and the magnetic domain 101 of the reproducing layer, which are disposed in a temperature area at a relatively low temperature, are coupled by the magnetic exchange coupling forces acting between the transition metals of the respective magnetic domains so that the directions of magnetization of the transition metals are identical. Therefore, as shown in FIG. 7, the magnetization information of the recording layer is transferred to the reproducing layer so that the direction of the overall magnetization of the magnetic domain 61 of the recording layer 6 is opposite to the direction of the overall magnetization of the magnetic domain 101 of the reproducing layer 10. The heating is effected to a temperature of not less than the Curie temperature of the expansion trigger layer 8 in the area of the spot center of the reproducing light beam 200. Accordingly, the magnetization of the expansion trigger layer 8 is extinguished (magnetic domain area 85 in FIG. 7).

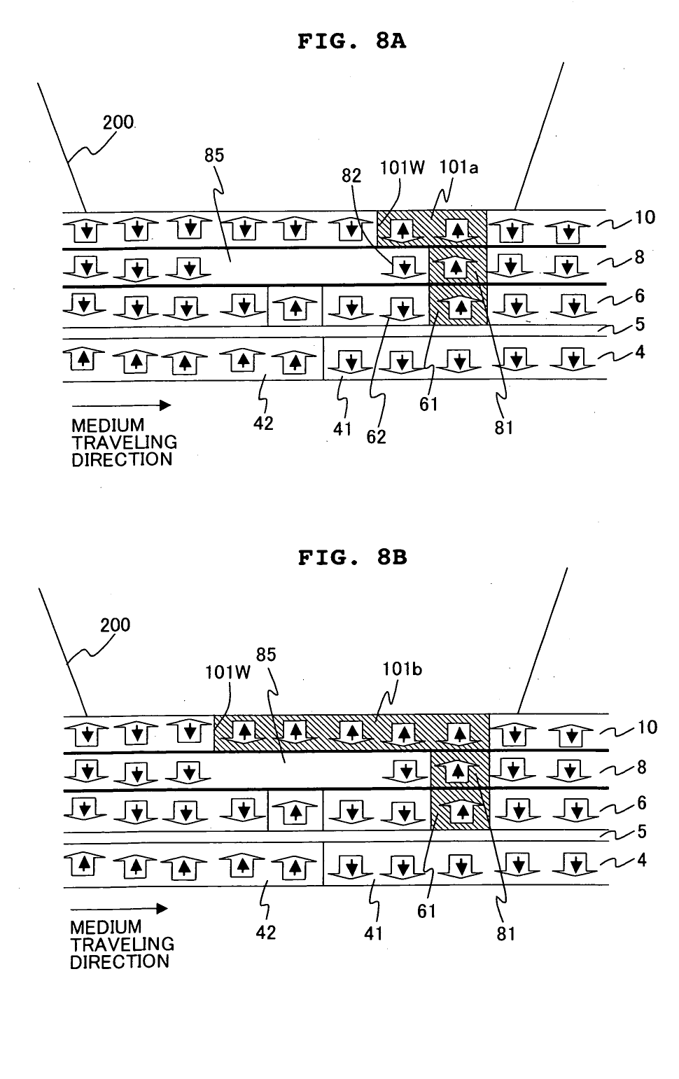

In the magneto-optical recording medium based on the Zero-Field MAMMOS manufactured in this embodiment, the magnetic characteristic of the expansion trigger layer 8 is regulated so that the exchange coupling force between the reproducing layer 10 and the recording layer 6 is suddenly weakened in the vicinity of the Curie temperature of the expansion trigger layer 8 (for example, in the vicinity of 150° C.). With reference to FIG. 7, the magnetic domain 102, which is disposed adjacently on the left side of the magnetic domain 101 of the reproducing layer 10, is heated to a temperature in the vicinity of the Curie temperature of the expansion trigger layer 8. In this area, the exchange coupling force between the magnetic domain 62 of the recording layer 6 and the magnetic domain 102 of the reproducing layer 10 formed thereover is extremely small. Therefore, the magnetostatic repulsive force is larger than the exchange coupling force between the magnetic domain 102 of the reproducing layer 10 and the magnetic domain 62 of the recording layer 6, because the direction of the overall magnetization of the magnetic domain 102 of the reproducing layer 10 is opposite to that of the magnetic domain 62 of the recording layer 6 formed thereunder. As a result, the magnetic domain 102 of the reproducing layer 10 is reversed by the magnetostatic repulsive force to give the magnetization state as shown in FIG. 8A. That is, the magnetostatic repulsive force, which acts between the recording layer 6 and the reproducing layer 10, is used as the trigger, and the magnetic domain 101 of the reproducing layer 10 shown in FIG. 7 is expanded as indicated by the magnetic domain 101a of the reproducing layer 10 shown in FIG. 8A. The stable magnetic domain diameter of the magnetic domain of the reproducing layer 10 is set to be sufficiently larger than the stable magnetic domain diameter of the recording layer. Therefore, the expanded magnetic domain 101a of the reproducing layer 10 shown in FIG. 8A is expanded to the high temperature area, i.e., the area 85 in which the exchange coupling force is cut off between the recording layer 6 and the reproducing layer 10. Thus, the expanded magnetic domain 101b is formed as shown in FIG. 8B.

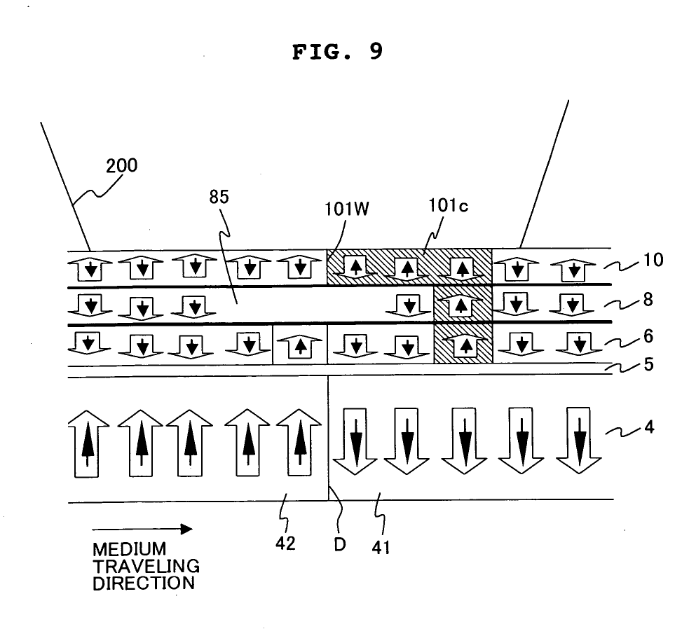

When the domain wall 101W of the magnetic domain 101 of the reproducing layer 10 is displaced and expanded during the reproduction as described above, if the thickness of the recording magnetic field assist layer 4 is thin to some extent, then the leak magnetic field generated from the recording assist layer 4 is also small, and hence the influence, which is exerted on the magnetic domain-expanding action of the reproducing layer 10 by the leak magnetic field generated from the recording assist layer 4, is small. However, as shown in FIG. 9, when the thickness of the recording magnetic field assist layer 4 is thick, then the leak magnetic field generated from the recording assist layer 4 is also increased, and the influence, which is exerted on the magnetic domain-expanding action of the reproducing layer 10 by the leak magnetic field generated from the recording assist layer 4, is also increased.

For example, in the case of the instance shown in FIG. 9, the leak magnetic field, which is generated from the recording magnetic field assist layer 4, acts to reverse the magnetic domain of the reproducing layer into the same direction as that of the overall magnetization of the expanded magnetic domain, and hence the magnetic domain is expanded in the area (magnetic domain area 41 in FIG. 9) in which the direction of the overall magnetization of the expanded magnetic domain 101c of the reproducing layer 10 is the same as the direction of the overall magnetization of the magnetic domain formed in the recording magnetic field assist layer 4. However, the leak magnetic field, which is generated from the recording magnetic field assist layer 4, acts to suppress the reversal of the magnetic domain of the reproducing layer 10 into the same direction as that of the overall magnetization of the expanded magnetic domain in the area (magnetic domain area 42 in FIG. 9) in which the direction of the overall magnetization of the expanded magnetic domain 110c is opposite to the direction of the overall magnetization of the magnetic domain formed in the recording magnetic field assist layer 4. Therefore, the magnetic domain is hardly reversed due to the influence of the leak magnetic field generated from the recording magnetic field assist layer 4 in the magnetic domain area of the reproducing layer 10 formed over the magnetic domain area 42 of the recording magnetic field assist layer 4. For example, as shown in FIG. 9, the domain wall 101W of the expanded magnetic domain 101c is stopped in some cases in the area of the reproducing layer 10 on the boundary D between the magnetic domain areas 41 and 42 of the recording magnetic field assist layer 4. In such a situation, the expanded magnetic domain 101c is smaller than the expanded magnetic domain 101b shown in FIG. 8B. Therefore, the reproduced signal, which is obtained from the expanded magnetic domain 101c shown in FIG. 9, is also smaller than the reproduced signal which is obtained from the expanded magnetic domain 101b shown in FIG. 8B. Therefore, if the thickness of the recording magnetic field assist layer 4 is too thick, CNR is lowered.

In order to supplement the decrease in CNR, it is considered to be necessary that CNR is improved by further improving the stability of the recording magnetic domain of the recording layer by further increasing the external magnetic field. However, the increase in the external magnetic field inhibits the versatility of the recording and reproducing apparatus, which results in the increase in the electric power. Therefore, as shown in FIG. 5, in order to obtain CNR of not less than 40 dB while using the external magnetic field having a practical magnitude, it is appreciated that the thickness of the recording magnetic field assist layer 4 is restricted to be not more than 190 nm.

### EXAMPLE 4

In Example 4, a variety of magneto-optical recording media having different coercivities of the magneto-optical recording media at 25° C. were manufactured. The coercivity of the magneto-optical recording medium at 25° C. was changed from 30 Oe to 300 Oe by changing the composition by changing the amount of Gd contained in the recording magnetic field assist layer while fixing the thickness of the recording magnetic field assist layer to be 100 nm. The magneto-optical recording media were manufactured in the same manner as in Example 1 except that the coercivity was changed.

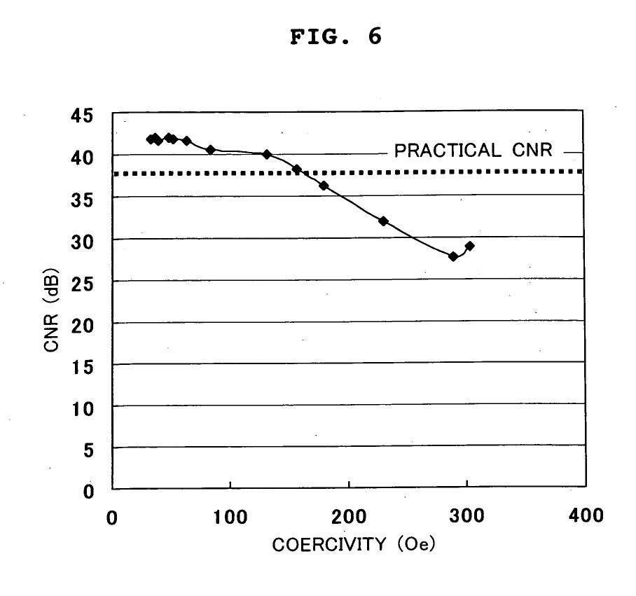

The coercivity was determined on the basis of a magnetization curve obtained by the measurement by measuring the dependency of the magnetization of the magneto-optical recording medium at 25° C. on the magnetic field in the same manner as in Example 1. The mark length of the recording magnetic domain formed in the recording layer was 100 nm. The relationship between CNR and the coercivity at 25° C. was investigated for the various magneto-optical recording media manufactured in Example 4. An obtained result is shown in FIG. 6. The following method is also available to measure the coercivity. That is, four terminals are provided for the magneto-optical recording medium to measure the dependency of the anomalous Hall effect on the magnetic field, and the coercivity is determined from a magnetization curve obtained from the measurement.

FIG. 6 shows the change of CNR with respect to the coercivity at 25° C. of the magneto-optical recording medium manufactured in Example 4. As clarified from FIG. 6, it has been revealed that CNR is decreased when the coercivity at 25° C. is increased. As explained in Example 1, the coercivity of the magneto-optical recording medium at 25° C. approximately corresponds to the coercivity of the recording magnetic field assist layer at 25° C. Therefore, it is understood that CNR is decreased when the coercivity of the recording magnetic field assist layer is too large. Accordingly, as clarified from FIG. 6, the following fact has been revealed on the basis of the practical CNR value of 38 dB (broken line shown in FIG. 6). That is, it is necessary that the coercivity of the magneto-optical recording medium at 25° C. and the coercivity of the recording magnetic field assist layer at 25° C. are not more than about 150 Oe.

### EXAMPLE 5

In Example 5, a magneto-optical recording medium based on the Zero-Field MAMMOS was manufactured by using a Co/Pt multilayer film for the recording magnetic field assist layer. The magneto-optical recording medium was manufactured in the same manner as in Example 1 except that the recording magnetic field assist layer was formed with the Co/Pt multilayer film. The recording magnetic field assist layer was formed by alternately stacking or alternately laminating forty layers of Co layers having a thickness of 0.2 nm and forty layers of Pt layers having a thickness of 0.9 nm by using a high frequency sputtering apparatus.

The coercivity of the magneto-optical recording medium at 25° C. was measured for the magneto-optical recording medium manufactured in Example 5 in the same manner as in Example 1. As a result, a value of 42 Oe was obtained. A playback test was performed in the same manner as in Example 1 to measure the external magnetic field required to obtain CNR of not less than 40 dB for the recording magnetic domain having a mark length of 100 nm. As a result, it has been revealed that an external magnetic field of not less than 156 Oe is required. That is, it has been revealed that the satisfactory reproduction characteristic is obtained even when the recording magnetic domain is formed in the recording layer with the external magnetic field smaller than that in Comparative Example 1 even when the Co/Pt multilayer film is used for the recording magnetic field assist layer. That is, it has been revealed that the effect to reduce the external magnetic field is obtained even when the multilayer film, which is obtained by alternately stacking the transition metal and the noble metal, is used for the recording magnetic field assist layer, without being limited to only the amorphous alloy composed of the base material of the rare earth transition metal alloy such as GdFeCo as in Example 1.

### EXAMPLE 6

In Example 6, a magneto-optical recording medium was manufactured by adding 2 at. % Cr to the recording magnetic field assist layer formed of the GdFeCo film. The magneto-optical recording medium was manufactured in the same manner as in Example 1 except that Cr was added by 2 at. % to the recording magnetic field assist layer.

The coercivity of the magneto-optical recording medium at 25° C. was measured for the magneto-optical recording medium manufactured in Example 6 in the same manner as in Example 1. As a result, a value of 53 Oe was obtained. The value was slightly higher than that of the coercivity (47 Oe) of the magneto-optical recording medium of Example 1. The playback test was performed in the same manner as in Example 1 to measure the external magnetic field required to obtain CNR of not less than 40 dB for the recording magnetic domain having a mark length of 100 nm. As a result, it has been revealed that an external magnetic field of not less than 124 Oe is required. This value was slightly lower than that of the required external magnetic field (about 125 Oe) measured in Example 1. That is, it has been revealed that the external magnetic field can be further reduced by adding a slight amount of Cr to the recording magnetic field assist layer when the amorphous alloy composed of the base material of the rare earth transition metal alloy such as GdFeCo is used as the recording magnetic field assist layer. It is also allowable to add, for example, Al and B other than Cr.

In Examples 1 to 6 described above, the explanation has been made about the magneto-optical recording medium based on the Zero-Field MAMMOS of the first surface type. However, the present invention is not limited thereto. For example, the present invention is also applicable to a magneto-optical recording medium based on MAMMOS of the first surface type which requires any reproducing magnetic field during the reproduction of information. Alternatively, the present invention is also applicable to a magneto-optical recording medium based on MAMMOS which requires any reproducing magnetic field and a magneto-optical recording medium based on the Zero-Field MAMMOS of the substrate incident type which is irradiated with the reproducing light beam through the substrate. Further alternatively, the present invention is also applicable to a magnetic recording medium based on the use of the magnetic recording system (light assist recording method) in which the recording is performed by lowering the coercivity of the magnetic layer by radiating the light beam.

According to the magneto-optical recording medium of the present invention, the recording magnetic field assist layer having a thickness of 30 to 190 nm is provided on the side opposite to the side of the trigger layer with respect to the recording layer. Accordingly, even when the external magnetic field generated from the magnetic coil is small, it is possible to generate the sufficiently large recording magnetic field. Therefore, even when the high recording density of information is further advanced, and the recording magnetic domain is made fine and minute, then it is possible to form the sufficiently stable recording magnetic domain. Therefore, the magneto-optical recording medium of the present invention is preferably usable as the magneto-optical recording medium capable of performing the high density recording, such as the magneto-optical recording medium based on the magnetic domain-expanding reproduction system or the magnetic amplifying magneto-optical system.

1. A magneto-optical recording medium comprising:
a recording layer which is formed of a magnetic material and in which information is recorded as magnetic domains;
a reproducing layer which is formed of a magnetic material and in which the magnetic domain magnetically transferred from the recording layer is expanded;
a first intermediate layer which is formed of a magnetic material and which is provided between the recording layer and the reproducing layer;
a recording magnetic field assist layer which is one of an amorphous alloy film containing GdFeCo as major component and a multilayer film formed by alternately stacking transition metal layers and noble metal layers, the recording magnetic field assist layer being provided on a side opposite to a side of the first intermediate layer with respect to the recording layer, and exhibiting perpendicular magnetization; and
a second intermediate layer which is provided between the recording layer and the recording magnetic field assist layer and which cuts off magnetic coupling between the recording layer and the recording magnetic field assist layer, wherein:
the recording magnetic field assist layer has a thickness of 30 to 190 nm.

2. The magneto-optical recording medium according to claim 1, wherein the second intermediate layer is formed of a paramagnetic material or a non-magnetic material.

3. The magneto-optical recording medium according to claim 1, wherein an initially magnetized area of the magneto-optical recording medium has a coercivity of not more than 150 Oe at 25° C.

4. The magneto-optical recording medium according to claim 1, wherein the recording magnetic field assist layer has a Curie temperature which is not less than a Curie temperature of the recording layer, and the recording magnetic field assist layer has a coercivity of not more than 150 Oe at 25° C.

5. The magneto-optical recording medium according to claim 1, wherein when a recording magnetic field is applied to the magneto-optical recording medium to record the information in the recording layer, magnetization of the recording magnetic field assist layer turns to a direction of the recording magnetic field.

6. The magneto-optical recording medium according to claim 1, wherein the information is recorded in the recording layer in accordance with a magnetic field modulation recording system.

7. The magneto-optical recording medium according to claim 1, further comprising a third intermediate layer which is formed of a material that exhibits paramagnetism or non-magnetism at room temperature, wherein the third intermediate layer is provided between the recording layer and the first intermediate layer and/or between the reproducing layer and the first intermediate layer.

8. The magneto-optical recording medium according to claim 1, wherein an external magnetic field is not more than 200 Oe when the information is recorded in the recording layer.
